(19) United States
(12) Patent Application Publication
(10) Pub. No.: US 2002/0072032 A1
(43) Pub. Date: Jun. 13, 2002

(54) Cavity flushing apparatus

(75) Inventors: Bruno Senn, Buchs (CH); Gabriela Bopp, Gofis (AT); Andreas Radl, Schaan (LI)

Correspondence Address: John C. Thompson, 69 Grayton Road, Tonawanda, NY, 14150, US

(73) Assignee: Ivoclar Vivadent AG

(21) Appl. No.: 09/992,188

(22) Filed: Nov. 5, 2001

Related U.S. Application Data
(60) Provisional application No. 60/266,722, filed on Feb. 5, 2001.

(30) Foreign Application Priority Data
Dec. 12, 2000 (DE) P 100 61 699.2

(51) Int. Cl. A61C 17/00; A61G 5/02

(52) U.S. Cl. 433/80; 433/81

(57) ABSTRACT

A flushing apparatus for cleaning a cavity space of a cavity space containing member such as a tooth or a restorative piece is provided. The flushing apparatus includes a working space in communication with a pump for producing a vacuum in the working space, a supply conduit communicated with the working space, and an outlet conduit with the working space. The working space is disposed in fluid communication with the cavity space and an oscillation generator creates oscillatory movement in the flushing fluid which is fluidly communicated into the working space and the cavity space. An adapter communicates the working space with the cavity space. The flushing apparatus is operable to place the working space in a vacuum condition relative to the tooth or the restorative piece.

### BACKGROUND OF THE INVENTION

The present invention relates to a flushing apparatus for flushing a cavity space and, especially, a flushing apparatus for flushing a cavity space of a tooth or a restorative piece in preparation for the handling of the tooth or the restorative piece.

A known flushing apparatus of the general type concerning the invention is disclosed in Canadian Patent 2,192,700. In this known flushing apparatus, the flushing fluid is conducted through a working space. The working space is connected with a pressure change generator. The working space is connected with a tooth cavity via a connection conduit, whereby a sealing off should be effectuated by a sealing element. In order to make ready the desired flow of the flushing fluid through the working space, an inflow container and an outflow container are positioned in such a way that the potential energy of the flushing fluid into the inflow container supports the fluid exchange in the working space.

Depending upon the surrounding environment B that is, the atmospheric pressure B an underpressure condition or an overpressure condition may correspondingly exist in the working space, depending upon how the inflow container and the outflow container are positioned.

In the above-described conventional flushing apparatus, however, the cavity space is in fluid communication with the working space. The connecting conduit, which can, for the sake of practicality, be a flexible connecting conduit, can extend in any desired suitable manner so that the working space can be as desired positioned above or under the cavity space, whereby the working space is, in most instances, disposed above the cavity space. In this manner, a minimum degree of freedom concerning accessibility is ensured.

In the above-described approach, the pressure change generator is configured such that intensive pressure waves result which are even sufficient to produce cavitation.

This leads, however, to considerable pressure waves which propagate in the cavity space.

On the other hand, it is important that precisely those root canals in the area of the apex are fully cleansed of tissue remainders for the reason that the restoration success is strongly dependent upon the degree of cleaning which is achieved.

An overly lengthy flushing or cleaning is perceived by the patient as uncomfortable and does not aid in winning acceptance of the use of such technology, whereby, in the general consideration of this approach, it is desirable to ensure the best possible rapid and intensive flushing.

Another consideration is that it is precisely the apex of a tooth, in fact, which is particularly sensitive. The danger exists that the unclean flushing fluid presses into the fine canals and fissures and, moreover, can no longer be flushed from there by intensive exchange with the flushing solution.

Moreover, it has already been proposed to mount a cleaning or flushing head directly on a tooth and to permit the cleaning canals to extend through a bore in the tooth into the cavity space. This solution, however, has the disadvantage that the flushing fluid also flows deep into the apex due to the flow surge. The success of the flushing procedure thus depends very greatly on the flow surge itself, whereby finer branched out root canals are less intensively cleaned and the larger cavity spaces are correspondingly more intensively cleaned. The dentist must therefore ensure, with this solution, that the cleaning procedure has a relatively lengthy duration, which is not desirable for a number of reasons.

### SUMMARY OF THE PRESENT INVENTION

The present invention provides a solution to the challenge of providing a flushing apparatus which makes possible an improved cleaning as well of the relatively finer canals in the apex region but which is nonetheless service reliable and permits ease of handling.

The flushing apparatus of the present invention is capable, by virtue of the use of a closed system, of initially producing a defined internal pressure which prevents the driving of cleaning fluid, which contains unclean matter, into the fine canals due to overpressure in the working space. By this approach, in which the working space is set off directly from the tooth or the restorative piece, it can be ensured that there continuously exists as well, between the cavity space and the working space, only a defined and reduced pressure differential.

In accordance with the present invention, it is advantageous if the adapter is supported from the tooth or restorative piece so that a secure mechanical connection is ensured which makes possible an efficient cleaning. The connecting conduits can be completely done away with so that an exchange between used and fresh cleaning solution via a considerably shortened distance can result, with the shortened distance comprising, for example, solely a few millimeters instead of several decimeters. surprisingly, the inventive oscillation generator can be positioned in the immediate neighborhood of the tooth or restorative piece B thus, typically it can be placed in the patient=s mouth. In this manner, an automatic relative positioning occurs between the cavity space and the working space.

The sealing between the adapter and the tooth or the restorative piece is improved due to the especially advantageous vacuum provided in accordance with the present invention; the adapter is in effect additionally suctioned into its disposition in the sealing area due to the vacuum on the tooth.

In accordance with an especially advantageous embodiment of the present invention, the tooth or the restorative piece is provided with a conical opening which is precisely tailored to the adapter. It is preferable that a precisely dimensioned drill be provided with which the opening can be duplicated. Additionally, the adapter includes on its outer conical periphery an elastomeric sealing lip which can be, for example, a rubber coating. The conical angle is preferably selected such that the adapter including the working space and the oscillation generator B thus, the working unit in its entirety B remains positioned or held on the tooth or the restorative piece after it has been initially pressed thereon but which can nonetheless be pulled off after the conclusion of the cleaning process.

In an advantageous embodiment of the present invention, an obstacle such as, for example, a barrier, is provided in the working space for the flowthrough between the supply conduit and the outlet conduit. This obstacle creates additional turbulence which promotes better exchange between the working space and the cavity space via the adapter canal. In this manner, the efficiency of the driven flow is reinforced without the drawback that a driven flow is introduced directly into the adapter canal.

The flushing apparatus of the present invention has the particular advantage that not only is there no grease or oil coating as occurs with mechanical removal of tooth root remainders but, additionally, the flushing apparatus of the present invention can dislodge and conduct away the remainder of the finest canals. It is to be understood that a suitable cleaning fluid such as sodium hypochlorite can improve the cleaning.

This is particularly necessary due to the vacuum within the entire flushing apparatus with respect to the surroundings which can be at a value, for example, of 150 millibar. The cleaning impact can be tailored to the requirements by adjustment of the working vacuum between the supply conduit and the outlet conduit in combination with the frequency of the oscillation generator. In this regard, it is particularly advantageous if the cleaning process is initially conducted at a reduced frequency and at a reduced working vacuum and is thereafter conducted at a higher working vacuum and a higher frequency. In this manner, the main portion of the root fabric or tissue is initially removed without the risk that the cleaning impacts the area of the apex.

During a subsequent cleaning process step, the working pressure is increased and, at the same time, the frequency of the oscillation generator is increased. In this manner, there occurs a stronger flow and smaller bubbles penetrate deeper up to and into the area of the apex. The stronger turbulence and bubbling movement leads to the result that heretofore unreachable remainders of root tissue can also be removed

In an advantageous embodiment of the flushing apparatus of the present invention, the oscillation generator includes an electric motor having an eccentric member mounted on its axis which is connected via a connection rod with the membrane. It is preferable that the connection between the connection rod and the eccentric member as well as the flange connection between the electric motor and the working unit are, as a rule, releasable. The working unit can then be comprised of disposable components so that a cleaning of the unit is not needed.

In an advantageous embodiment of the flushing apparatus of the present invention, the system is controlled via a central control. Pressure sensors, flow sensors, and temperature sensors monitor all important parameters of the flushing apparatus and, in the event of a failure of a function, a corresponding signal is generated. A flow sensor can also be provided to monitor the flow moving through the electric motor such that the motor can neither be blocked nor left to run in neutral, while a predetermined flow window is monitored.

### BRIEF DESCRIPTION OF THE DRAWING

Additional advantages, details, and features are set forth in the following description of an embodiment in connection with the drawings, in which:

FIG. 1 is a schematic view of one exemplary embodiment of the flushing apparatus of the present invention; and

FIG. 2 is an enlarged side view of a working unit of the flushing apparatus shown in FIG. 1.

### DETAILED DESCRIPTION OF THE PREFERRED EMBODIMENTS

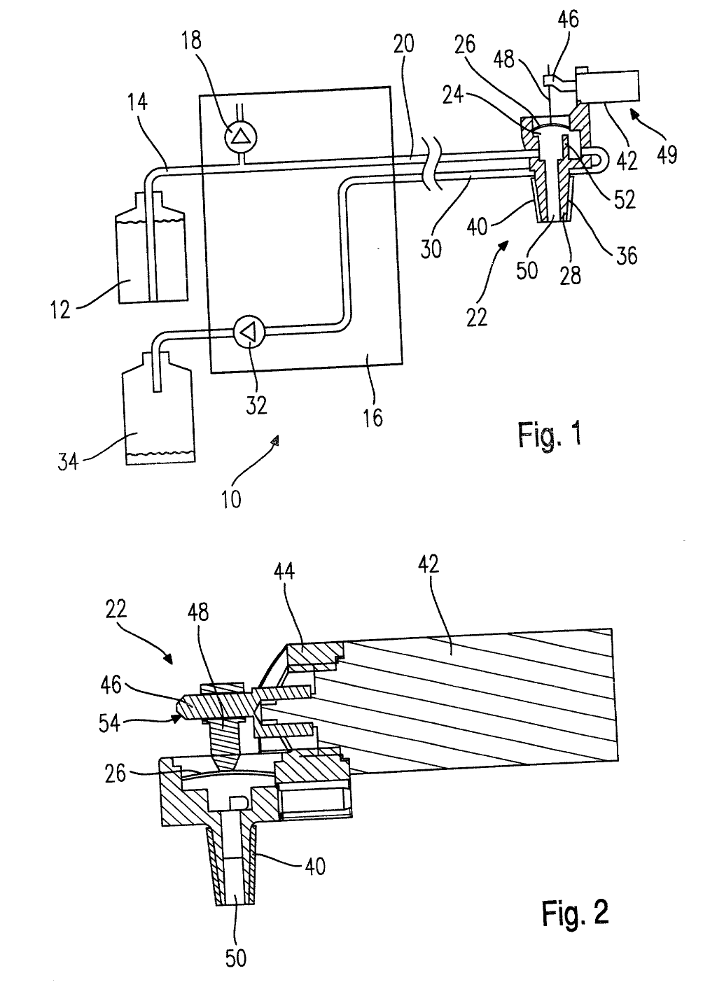

An embodiment of the flushing apparatus 10 of the present invention is schematically illustrated in FIG. 1. The flushing apparatus includes a closed cleaning system. In this regard, a supply container 12 contains a supply of flushing fluid. The supply container is connected via a connection 14 with a control unit 16. In the illustrated embodiment, a pump 18 is provided which produces a less than atmospheric vacuum through the connection 14.

The connection 14 extends into a supply conduit 20 which extends into the inventive working unit 22. The supply conduit communicates at the working unit with a working space 24. The working space 24 is bounded at the top by a membrane 26. An adapter 28 of the working unit 22 extends from the bottom of the working space 24. The flushing fluid flows through the working space 24 to an outlet conduit 30 which leads back to the control unit 16. In the illustrated embodiment of the flushing apparatus, an additional pump 32 is provided at this location which acts as a working pump and provides the working vacuum for the cleaning process. The flushing fluid flows from the pump 32 into a receiving container 34 which is the same size as the supply container 12.

In the treatment of a tooth or a restorative piece, initially a special drill, which is not illustrated, creates a conical opening in the tooth. In this event, and in the following described process events, reference is made for the sake of simplicity only to a tooth although it is to be understood that a suitable restorative piece to be cleansed can be cleaned in a corresponding fashion. The special drill includes a drill bit for centering and thereafter drilling a defined outer cone which corresponds to the conical outer surface 36 of the adapter 28. The drill is closed off from the top down by a flat plate which prevents drilling beyond a prescribed depth.

Following the creation of the opening, the adapter 28 is introduced into the opening. The outer surface 36 thereof is provided with a build up or sealing material 40 which on the one hand provides good tractive grip in the opening and on the other hand seals off the opening so that no air leakage can slip in. In this condition, the adapter is now ready to produce the fluid connection between the working space 24 and the cavity space of the tooth. In this regard, the pumps 18 and 32 are actuated so that the entire system is placed under a vacuum and then flushing fluid can be drawn from the supply container 12. So long as there is no loss of seal, the pump 18 can then be turned off so that no flushing fluid loss occurs.

As soon as the flushing fluid reaches the adapter, the electric motor 42 is energized. The electric motor 42 is coupled to the working unit 22 via a flange 44 (FIG. 2) and includes an eccentric member 46 which acts on a connection rod 48. The connection rod 48 is connected to the membrane 26 so that the energization of the electric motor 42 effects an actuation of the oscillation generator 49. Turbulence and bubbling arise from the oscillation pulses in the working space 24 and in the adapter canal 50 of the adapter 28. The turbulence and bubbling travel through the adapter 50 as well into the cavity space of the tooth up to and into the apex thereof so that they contribute to the removal of the root tissue. At the same time, the operation of the working pump 32 causes a flow of the flushing fluid transversely through the working space 24. This flow does not, however, travel linearly but, instead, moves in a turbulent manner by means of a defined barrier 52. The resultant turbulence is sufficient to achieve the desired cleansing.

Details of the working unit 22 can be seen in FIG. 2. The same reference numerals are used in FIG. 2 as in FIG. 1 so that a further description thereof is omitted. The illustration in FIG. 2 permits a better view of how the electric motor 42 is secured by threaded attachment of the flange 44 to the working unit 22. The eccentric member 46 correspondingly preferably includes guide-in slopes 54 to facilitate the guiding in of the connection rod 48 into the recess.

It is further possible to operate the inventive flushing apparatus for bleaching purposes. In this regard, a bleaching solution such as hydrogen peroxide is circulated instead of the flushing fluid and the desired whitening or bleaching is thereby accomplished.

In accordance with an alternate configuration of the inventive flushing apparatus, the flushing apparatus can be used for the cleaning and/or whitening of dental areas other than teeth cavity areas. For example, the flushing fluid applied by the flushing apparatus of the present invention is also effective in cleaning teeth pockets. In this connection, an adapter having an elastic sealing lip is provided which permits a sealing off of the area of the tooth pocket. The sealing off is advantageously reinforced by the vacuum which is produced during the cleaning procedure.

It is also possible to configure the adapter such that it completely or partially surrounds a tooth or a restorative piece and to then circulate a whitening solution through the flushing apparatus, whereupon, for example, the tooth is intensively and, especially, uniformly, whitened.

In a further configuration of the flushing apparatus of the present invention, it is provided that a dental assistance means, a dental tool, or the like is subjected to a cleaning procedure by the flushing apparatus, whereby a corresponding adapter is required.

The present invention is, of course, in no way restricted to the specific disclosure of the specification and drawings, but also encompasses any modifications within the scope of the appended claims.

What we claim is:

1. A flushing apparatus for cleaning a cavity space of a cavity space containing member which is a selected one of a tooth and a restorative piece, comprising:
a working space in communication with a means for producing a vacuum in the working space;
a supply conduit having its outlet end communicated with the working space;
an outlet conduit having its inlet end communicated with the working space, the working space being disposable in fluid communication with the cavity space;
an oscillation generator for creating oscillatory movement in the flushing fluid which is fluidly communicated into the working space and the cavity space; and
an adapter disposable in communication with the cavity space and connected with the working space, whereby the flushing apparatus is operable to place the working space in a vacuum condition relative to the respective cavity space containing member.

2. A flushing apparatus according to claim 1 wherein the flushing apparatus is operable to place the supply conduit and the outlet conduit in a vacuum condition relative to the surroundings.

3. A flushing apparatus according to claim 1 wherein the adapter includes an outer conical surface compatibly configured with respect to a conically shaped opening in the respective cavity space containing member.

4. A flushing apparatus according to claim 3 wherein the adapter includes a sealing material adapted for receipt in the opening in the respective cavity space containing member.

5. A dental treatment apparatus comprising:
a flushing apparatus for cleaning a cavity space of a cavity space containing member which is a selected one of a tooth and a restorative piece having
a working space in communication with a means for producing a vacuum in the working space,
a supply conduit having its outlet end communicated with the working space,
an outlet conduit having its inlet end communicated with the working space, the working space being disposable in fluid communication with the cavity space,
an oscillation generator for creating oscillatory movement in the flushing fluid which is fluidly communicated into the working space and the cavity space, and
an adapter disposable in communication with the cavity space and connected with the working space, whereby the flushing apparatus is operable to place the working space in a vacuum condition relative to the respective cavity space containing member; and
a drill having a conical outer surface and operable to create an opening in the respective cavity space containing member for communication therethrough between the cavity space and the flushing apparatus.

6. A flushing apparatus according to claim 1 wherein the flushing apparatus is operable as a hermetically closed system which maintains the flushing fluid hermetically isolated from the surroundings and further comprising a pump operable to produce a vacuum of between 50 to 500 mbar with respect to the surroundings, preferably approximately 150 mbar.

7. A flushing apparatus according to claim 6 and further comprising a second pump operable to produce a pressure differential between the supply conduit and the outlet conduit which is less than the vacuum pressure and is between 50 to 100 mbar.

8. A flushing apparatus according to claim 1 and further comprising a membrane which bounds the working space and is operatively connected with the oscillation generator.

9. A flushing apparatus according to claim 1 wherein the working space and the means for producing a vacuum are configured relative to one another such that, upon actuation of the means for producing a vacuum and without operation of the oscillation generator, substantially no flow exists between the cavity space and the working space.

10. A flushing apparatus according to claim 1 wherein the oscillation generator is operable to produce bubbling in the flushing fluid which can be conducted through an adapter canal.

11. A flushing apparatus according to claim 1 wherein the adapter includes an adapter canal arranged such that a flow induced by a pump does not flow through the adapter canal.

12. A flushing apparatus according to claim 1 wherein the oscillation generator is configured as a selected one of an electric motor having an eccentric member, a piezoelectric oscillation generator, and an electromagnetic device.

13. A flushing apparatus according to claim 1 wherein the adapter includes an outer conical surface and is configured to be self-retaining on the cavity space containing member.

14. A flushing apparatus according to claim 1 wherein the adapter includes an adapter canal and the oscillation generator is operable to produce turbulence in the flushing fluid flowing through the working space which contributes to the fluid exchange along the adapter canal.

15. A flushing apparatus according to claim 1 wherein the flushing apparatus is operable to circulate a flushing fluid comprised of sodium hypochlorite.

16. A flushing apparatus for cleaning a dental pocket of the type in which a tooth or a restorative piece is located, comprising:
a working space in communication with a means for producing a vacuum in the working space;
a supply conduit having its outlet end communicated with the working space;
an outlet conduit having its inlet end communicated with the working space, the working space being disposable in fluid communication with the dental pocket;
an oscillation generator for creating oscillatory movement in the flushing fluid which is fluidly communicated into the working space and the dental pocket; and
an adapter disposable in communication with the cavity space and connected with the working space, whereby the flushing apparatus is operable to place the working space in a vacuum condition relative to the dental pocket.

17. A flushing apparatus according to claim 16 and further comprising an elastic sealing lip for disposal of the adapter and the dental pocket in communication with one another in a sealing manner to permit a vacuum to be produced through the adapter.

18. A flushing apparatus according to claim 16 wherein the flushing apparatus is operable to circulate a bleaching solution comprising H₂O₂ for whitening treatment of a tooth or a restorative piece.
